(19) United States
(12) Patent Application Publication
(10) Pub. No.: US 2004/0024781 A1
(43) Pub. Date: Feb. 5, 2004

(54) Method of comparing version strings

(75) Inventor: David W. Youd, Livermore, CA (US)

Correspondence Address: James S. Tak, Assistant Laboratory Counsel, Lawrence Livermore National Laboratory, P.O. Box 808 , L-703, Livermore, CA, 94551, US

(73) Assignee: The Regents of the University of California

(21) Appl. No.: 10/211,622

(22) Filed: Aug. 1, 2002

(51) Int. Cl. G06F 17/30

(52) U.S. Cl. 707/104.1

(57) ABSTRACT

A method of comparing version strings in a computing environment for use in version-specific computing tasks. In one embodiment, the method divides each of a first and a second version string at each one of a set of predetermined delimiters to produce respective first and second sets of sequentially ordered string chunks. Next, string chunks of the same order from the first and second chunk sets are iteratively compared to determine matching of same-order string chunks, with the comparison continuing until a non-matching same-order string chunk pair is encountered. From the matching/non-matching comparisons, a determination may be made whether a specified quality relationship exists between the first and second version strings, where the quality relationship determines the propriety of a version-specific computing task.

The United States Government has rights in this invention pursuant to Contract No. W-7405-ENG-48 between the United States Department of Energy and the University of California for the operation of Lawrence Livermore National Laboratory.

### FIELD OF THE INVENTION

The present invention relates to a method and system of comparing version strings associated with hardware, software, firmware, operating systems, etc, and more particularly to the comparison of such version strings for equality, inequality, or commonality by matching corresponding string chunks and subchunks to thereby determine the propriety of a version-specific computing task.

### BACKGROUND OF THE INVENTION

Most everything dealing with computers, i.e. hardware or software, has a version associated with it enabling users to identify and compare different versions of components and decide which is newer. Versions often also indicate bug patch levels, the stability of the component, major milestones, target operating systems, etc. Version strings, however, are often characterized as semi-structured data in that they often make sense to the human reader but are not in a form that readily lends itself to machine sequencing and automation. This often makes representing and using version strings as objects (i.e. well-defined pieces of data responsive to queries about the data) more difficult by limiting the ability to compare version strings both for equality (e.g. for determining commonality between strings), and for inequality (e.g. for purposes such as sorting by name or date). As such, version string data may often remain simply as data, and not be transformed into useful information from which various version-specific and version-dependent computing operations may be initiated.

### SUMMARY OF THE INVENTION

One aspect of the present invention includes a method of comparing version strings in a computing environment for enabling version-specific computing tasks, the method comprising: dividing each of a first and a second version string at each one of a set of predetermined delimiters to produce respective first and second sets of sequentially ordered string chunks; iteratively comparing string chunks of the same order to determine if matching therebetween, wherein the comparison of same-order string chunks continues until a non-matching same-order string chunk pair is encountered; and determining that a specified quality relationship exists between the first and second version strings only if the matching comparisons satisfy a set of predetermined matching/non-matching conditions thereof, wherein the specified quality relationship determines execution of a version-specific computing task.

Another aspect of the present invention includes a method of determining, in a computing environment, version hierarchy between version strings for enabling version-specific computing tasks, the method comprising: designating a reference version string against which version string comparisons may be made; identifying a test version string associated with a test version of a computer device in the computing environment; dividing each of the test and reference version strings at each one of a set of predetermined delimiters to produce respective test and reference sets of sequentially ordered string chunks; iteratively comparing string chunks of the same order to determine if matching therebetween, wherein the comparison of same-order string chunks continues until a non-matching same-order string chunk pair is encountered; and determining version hierarchy between the first and second version strings from the matching comparisons and in accordance with a set of predetermined matching/non-matching conditions, wherein the version hierarchy determines execution of a version-specific computing task.

Another aspect of the present invention includes a computer system for comparing version strings for use in enabling version-specific computing tasks, the computer system comprising: a first module that divides each of a first and a second version string at each one of a set of predetermined delimiters to produce respective first and second sets of sequentially ordered string chunks; a second module that iteratively compares string chunks of the same order to determine if matching therebetween, wherein the comparison of same-order string chunks continues until a non-matching same-order string chunk pair is encountered; and a third module that determines that a specified quality relationship exists between the first and second version strings only if the matching comparisons satisfy a set of predetermined matching/non-matching conditions thereof, wherein the specified quality relationship determines execution of a version-specific computing task.

Another aspect of the present invention includes a computer system for determining version hierarchy between version strings for use in version-specific computing tasks, the computer system comprising: a first module that designates a reference version string against which version string comparisons may be made; a second module that identifies a test version string associated with a test version of a computer device in a computing environment; a third module that divides each of the test and reference version strings at each one of a set of predetermined delimiters to produce respective test and reference sets of sequentially ordered string chunks; a fourth module that iteratively compares string chunks of the same order to determine if matching therebetween, wherein the comparison of same-order string chunks continues until a non-matching same-order string chunk pair is encountered; and a fifth module that determines a version hierarchy between the first and second version strings from the matching comparisons and in accordance with a set of predetermined matching/non-matching conditions, wherein the version hierarchy determines execution of a version-specific computing task on the test version of the computer device.

Another aspect of the present invention includes a computer program product comprising: a computer usable medium and computer readable code embodied thereon for comparing version strings to enable version-specific computing task, the computer readable code comprising: computer readable program code means for causing a computer to divide each of a first and a second version string at each one of a set of predetermined delimiters to produce respective first and second sets of sequentially ordered string chunks; computer readable program code means for causing the computer to iteratively compare string chunks of the same order to determine if matching therebetween, wherein the comparison of same-order string chunks continues until a non-matching same-order string chunk pair is encountered; and computer readable program code means for causing the computer determine that a specified quality relationship exists between the first and second version strings if the matching comparisons satisfy a set of predetermined matching/non-matching conditions, wherein the specified quality relationship determines execution of the version-specific computing task.

Another aspect of the present invention includes a computer program product comprising: a computer usable medium and computer readable code embodied thereon for determining version hierarchy between version strings for enabling version-specific computing tasks, the computer readable code comprising: computer readable program code means for causing a computer to designate a reference version string against which version string comparisons may be made; computer readable program code means for causing the computer to identify a test version string associated with a test version of a computer device; computer readable program code means for causing the computer to divide each of the test and reference version strings at each one of a set of predetermined delimiters to produce respective test and reference sets of sequentially ordered string chunks; computer readable program code means for causing the computer to iteratively compare string chunks of the same order to determine if matching therebetween, wherein the comparison of same-order string chunks continues until a non-matching same-order string chunk pair is encountered; and computer readable program code means for causing the computer to determine a version hierarchy between the test and reference version strings from the matching comparisons and in accordance with a set of predetermined matching/non-matching conditions, wherein the version hierarchy determines execution of a version-specific computing task on the test version of the computer device.

Another aspect of the present invention includes a method of automatic version upgrading in a computing environment, the method comprising: designating a reference version string representing a version string threshold for upgrading to a pre-selected version of a computer code; detecting from the computing environment a test version string associated with a test version of the computer code; dividing each of the test and reference version strings at each one of a set of predetermined delimiters to produce respective first and reference sets of sequentially ordered string chunks; iteratively comparing string chunks of the same order to determine if matching therebetween, wherein the comparison of same-order string chunks continues until a non-matching same-order string chunk pair is encountered; determining from the matching comparisons that a specified quality relationship exists between the test and reference version strings if the matching comparisons satisfy a set of predetermined matching/non-matching conditions, wherein the specified quality relationship determines propriety of upgrading the test version to the pre-selected version of the computer code; and if proper, upgrading the test version to the pre-selected version of the computer code.

Another aspect of the present invention includes a method of determining license compliance in a computing environment, the method comprising: designating a reference version string for use as a qualifier for determining compliance of a version of a computer code; detecting from the computing environment a test version string associated with a test version of the computer code; dividing each of the test and reference version strings at each one of a set of predetermined delimiters to produce respective test and reference sets of sequentially ordered string chunks; iteratively comparing string chunks of the same order to determine if matching therebetween, wherein the comparison of same-order string chunks continues until a non-matching same-order string chunk pair is encountered; and determining that a specified quality relationship exists between the test and reference version strings if the matching comparisons satisfy a set of predetermined matching/non-matching conditions, wherein the specified quality relationship determines compliance of the test version of the computer code.

Another aspect of the present invention includes a method of determining vulnerabilities in a computing environment associated with known versions of a computer code, the method comprising: designating a reference version string for use in determining the presence of a vulnerability; detecting from the computing environment a test version string associated with a test version of the computer code; dividing each of the test and reference version strings at each one of a set of predetermined delimiters to produce respective test and reference sets of sequentially ordered string chunks; iteratively comparing string chunks of the same order to determine if matching therebetween, wherein the comparison of same-order string chunks continues until a non-matching same-order string chunk pair is encountered; and determining that a specified quality relationship exists between the reference and test version strings if the matching comparisons satisfy a set of predetermined matching/non-matching conditions, wherein the specified quality relationship determines the presence of a vulnerability in the computing environment due to the test version of the computer code.

### BRIEF DESCRIPTION OF THE DRAWINGS

The accompanying drawings, which are incorporated into and form a part of the disclosure, are as follows:

FIG. 1 is a flow diagram of a first general embodiment of the present invention.

FIG. 2 is a flow diagram of an illustrative example corresponding to the steps of FIG. 1.

FIG. 3 is a flow diagram for determining what is common between a pair of version strings according to an embodiment of the present invention.

FIG. 4 is a flow diagram for determining if a pair of version strings match according to an embodiment of the present invention.

FIG. 5A is a flow diagram for determining if a first version string is less than or equal to a second version string according to an embodiment of the present invention.

FIG. 5B is a continuation flow diagram from FIG. 5A.

FIG. 6 is a flow diagram for determining if a first version string is greater than or equal to a second version string according to an embodiment of the present invention.

FIG. 7A is a flow diagram for determining if a first string subchunk of a non-matching string chunk pair is less than a same-order second string subchunk of the non-matching string chunk pair.

FIG. 8 is a flow diagram for determining if a first string subchunk of a non-matching string chunk pair is greater than a same-order second string subchunk of the non-matching string chunk pair.

FIG. 8B is a continuation flow diagram from FIG. 8A.

### DETAILED DESCRIPTION

The present invention is a method and system of comparing version strings of a computer device or product, allowing for equality comparisons, inequality comparisons, and commonality comparisons. The term “computer device” is used herein and in the claims to include both computer hardware and different forms of computer code, including software, firmware, operating systems, and equivalents thereof. Additionally, and as discussed in the background, version strings are semi-structured data associated with and identifying the version of a particular computer device. Generally, the present invention operates to transform the semi-structured version string data into useful information describing a hierarchical relationship between two version strings. A pair of version strings may be compared to determine a first impression hierarchical relationship therebetween (i.e. greater than, less than, or equal to). Or in the alternative, a specified or proposed quality relationship between a pair of version strings may be validated or disaffirmed in a comparative inquiry, (i.e. determining if the specified quality relationship holds true for a given pair of version strings). As used herein and in the claims, the term “quality relationship” is used to include any one of the following: (1) version equivalence, where two version strings are equivalent, (2) version inequality including less-than-or-equal version inequality and greater-than-or-equal version inequality, and (3) version commonality, where at least one component portion is equivalent between two version strings. Each will be described as exemplary embodiments in the following discussion.

The determination of a hierarchical relationship or specified quality relationship, which results from the version string comparison of the present invention serves to determine and enable the execution of a version-specific computing task. These are computing tasks which are dependent on the version of the particular copy of code under consideration, such as the upgrading of an older code version to a newer version. While the present invention is intended to enable many types of version-specific computing tasks, four exemplary applications are discussed herein to illustrate the determination and enablement of a version-specific computing task provided by the present invention. The methods presented herein have been tested on a database of 3693 version strings, with their associated vendors and product names (e.g. Microsoft® IIS 4.0).

It is notable that only rarely are overrides to the above rules necessary, and then only on a vendor and product name basis. For example, you could perform an override to a particular version comparison rule for all the versions associated with the collection of Netscape® Communicator software packages. This can be done by associating a bit field with each vendor/product name pair, with each bit corresponding to a rule for overriding. These simple overrides will be enumerated as needed in the following descriptions of the methods (though not shown in the drawings), and simply include turning off existing logic rather than adding more. Furthermore, where reference is made in any one or more of the accompanying drawings to steps and/or features, which have the same reference numerals, these steps and/or features have for the purposes of this description the same function(s) or operation(s), unless the contrary intention appears.

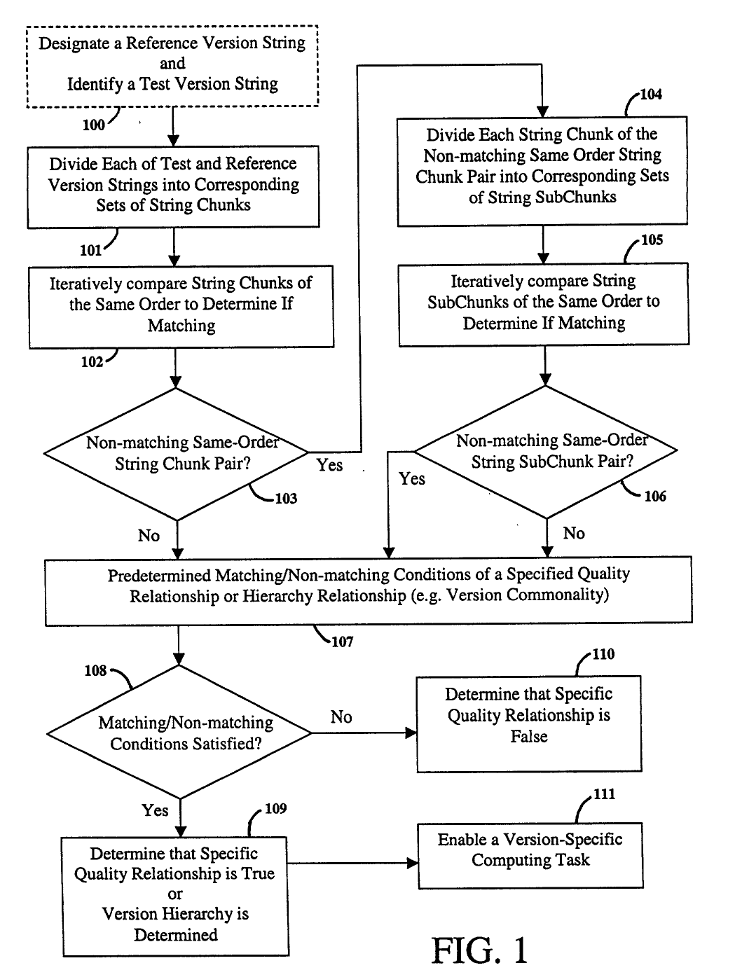

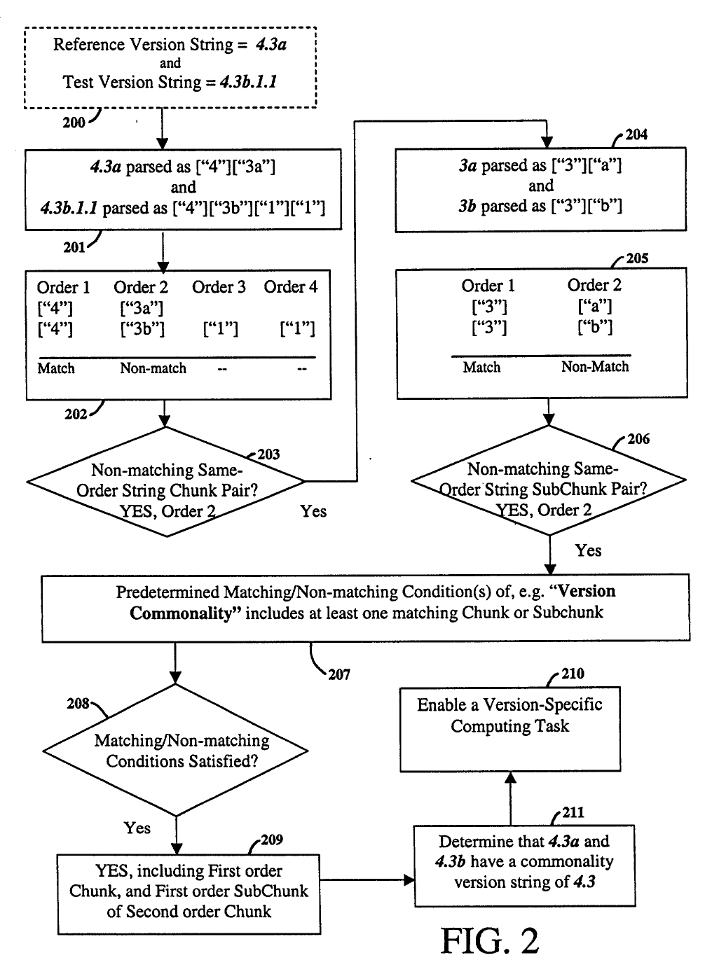

Turning now to the drawings, FIG. 1 shows a flow chart of a generalized exemplary embodiment of the present invention. And FIG. 2 shows a flow chart of an example case in step-by-step illustrative correspondence with FIG. 1. At preliminary steps 100 and 200, first and second version strings are chosen for comparative consideration. One of the two version strings is typically designated as the reference version string against which all other version strings are compared against. And the other of the two version strings is typically designated as the test version string which is the object of the comparative inquiry. Alternatively, two version strings may be compared without first labeling test and reference version strings. In FIG. 2, “4.3a” is designated the reference version string, and “4.3b.1.1” is identified as the test version string. It is notable that, for purpose of the present discussion, the two version strings are assigned to either a left hand operand (hereinafter “LHO”) or a right hand operand (hereinafter “RHO”). It is appreciated, however, that the designation of LHO or RHO is of little importance to the present invention since, for example, if “A=B” then “B=A”, and also if “A≦B” then “B≧A”. This notwithstanding, version strings are assigned to the LHO or RHO in order to establish and properly frame the inquiry, such as “is 3≦4 true?”

Next, each of the test and reference version strings are divided or parsed into string components, such as string chunks and string subchunks. At steps 101 and 201, each of the test and reference version strings are shown first divided into first-level string segments or “chunks,” wherever certain predetermined delimiters are found in the version string. The set of predetermined delimiters may include, for example, a decimal point/dot/period “.”, a dash/hyphen “-”, or a space “ ”, or may include all three delimiters. Other predetermined delimiters, such as underscores, may additionally be selected as determined by conventions in the data processing arts. In any case, the delimiters in a version string serve as boundaries between adjacent chunks. The delimiters themselves, however, are not included as an element of the chunks themselves. The division or segmentation of the version string into chunks produces a sequentially ordered set of chunks comprising at least one chunk. The chunks are sequentially ordered, for example, in increasing order from left to right of the version strings. The left to right ordering can be seen at step 202.

Next, at step 102 and 202, same-order chunks are iteratively compared with each other to determine if they match. These matching comparisons preferably occur in increasing sequential order from left to right, with the matching comparisons continuing until a non-matching same-order string chunk is encountered. It is notable that a non-matching same-order chunk pair indicates that the two version strings are not equal. Non-equality does not preclude a finding of commonality between version strings, however, as will be discussed in detail on version commonality. As can be seen at step 202, the first order chunks “4” of each of the version strings are a match. However, the second order chunks “3a” and “3b” of the reference and test version strings, respectively, do not match. In the order 3 and order 4 columns shown at step 202, it can be seen that same-order string chunk pairs are not available for comparison. Thus the iterative comparison only continues up to order 2. It is notable that “matching” involves both identical matching, as well as variable matching. Identical matching is readily understood to involve identical string components. And variable matching occurs when at least one string chunk of a same-order string chunk pair consists entirely of a variable or “wildcard”. For purposes of the present invention, wildcards are defined and allowable only at the chunk level and not at the subchunk level. Version wildcards must constitute an entire chunk to be considered a wildcard. For example, “Netscape Communicator 3.x.2” contains a wildcard, but “Sun Solaris 7.0_x86” does not because the “x” is referring to an Intel architecture type. Wildcards match any corresponding chunk (e.g. “1.x” matches “1.3”), but will not match a missing corresponding chunk, such as “1.x” and “1”). Another example, an equality match would find that the version “3.x” matches the version “3.5.5.b” because the “x” is generally understood to represent a wild card.

At steps 103 and 203, a determination is made whether a non-matching same-order string chunk pair is encountered from the matching comparisons of same-order string chunk pairs. As mentioned previously, the second order chunks “3a” and “3b” are not matching. Thus, at steps 104 and 204 each chunk is further divided into smaller string segments or “subchunks” which are a smaller type of string component than string chunks. Subchunks are comprised of at least one adjacent character element belonging to the same predetermined category. Subchunk categories may include numeric, alpha (e.g. “A” and “b”), and symbolic categories (excluding those symbols designated as delimiters). The character elements are preferably ASCII characters chosen from the various predetermined subchunk categories, and arranged and read from left to right. Hierarchical ordering within any particular subchunk category follows inherent conventions for ordering characters within the group, such as numerical ordering and alphabetical ordering. Therefore, for example, “4” has a higher or latter value than “3”, and “b” has a higher or latter value than “a”. Additionally, comparisons in the present invention are preferably case insensitive, since case sensitivity is rarely a factor in version precedence. Applying the above considerations at step 204, the chunk “3a” is divided into a first order subchunk “3” and a second order subchunk “a”. Similarly, the chunk “3b” is divided into a first order subchunk “3” and a second order subchunk “b”.

As an illustration of the grouping of chunks and subchunks, Table 1 shows three example version strings which are decomposed into chunks (surrounded by brackets [ ]), and subchunks (surrounded by quotes “ ”) below:

TABLE 1

a) “4.7b14” parsed as [“4”] [“7” “b” “14”]
b) “0.2pre-4” parsed as [“0”] [“2” “pre”] [“4”]
c) “2.4.2 (beta 18) VR15” parsed as
[“2”] [“4”] [“2”] [“(“ “beta”] [“18” “)”] [“VR” “15”]

After the dividing step, string subchunks in the non-matching same-order string chunk are iteratively compared to determine matching in steps 105 and 205. Similar to the comparison of same-order string chunks in step 102 and 202, the comparison of same-order string subchunks continues in increasing sequential subchunk order from left to right until a non-matching same-order string subchunk pair is encountered. Step 205 shows that the second order string subchunk pair “a” and “b” are non-matching. Upon encountering a non-matching string subchunk pair at steps 106 and 206, a further determination (not shown) may be made to determine the nature of the inequality. This is preferably accomplished by applying inter-categoric ordering rules, such as holding that alpha characters (and subchunks) are less than numeric characters (and subchunks). Additionally, another rule to be applied for subchunk comparison is that for numeric string subchunks, a numeric string subchunk with a greater number of leading zeros is less than a numeric string subchunk with fewer leading zeros. For example, “001” is less than “01”. Whether a non-matching same-order string subchunk pair is found or not, the results are forwarded to step 107 and 207 to determine satisfaction of a predetermined set of matching/non-matching conditions.

At steps 107-109 and 207-209, a determination is made from all the matching comparisons, both for string chunks and string subchunks, whether a specified quality relationship exists between the first and second version strings. As mentioned previously, a quality relationship includes version equivalence, greater-than-or-equal version inequality, less-than-or-equal version inequality, and version commonality. It is notable that the term “specified quality relationship” indicates an interest in determining whether a particular or specified quality relationship holds true for a given pair of version strings, i.e. to validate or disaffirm the specified quality relationship therebetween by returning a Boolean (true or false). To make this determination a predetermined set of matching/non-matching conditions is established for the specified quality relationship, shown at steps 107 and 207.

In FIG. 2, for example, it is desirable to determine what, if anything, of the test version “4.3b.1.1” is in common with the reference version string “4.3a”. The matching condition required to make this particular determination is that at least one same-order chunk or subchunk pair is matching between the version strings. This is determined at steps 108 and 208. Other matching/non-matching conditions are discussed below for other types of quality relationships. If the matching/non-matching conditions are not satisfied then the specific quality relationship is determined to be false at step 110. If, however, the matching/non-matching conditions are satisfied, then true is returned at step 109. For corresponding step 209, the first order chunk “4” is determined to match, as well as the first order subchunk of the second order chunk “3”. Therefore the condition for version commonality is satisfied, as indicated at step 211. This in turn enables a version-specific computing task at steps 111 and 210.

As an alternative to the validation or disaffirmance of a specified quality relationship, the present invention may seek to determine version hierarchy between two version strings without suggesting any quality therebetween. Similar to the determination of a specified quality relationship, a hierarchical relationship is determined in accordance with the predetermined set of matching/non-matching conditions. In this case, however, the predetermined set of matching/non-matching conditions is not intended to validate or disaffirm one type of specified quality relationship. Rather, the matching/non-matching conditions used for a hierarchy determination include conditions for version equivalence, version inequality (greater-than-or-equal and less-than-or-equal) and even version commonality. Similar to the case of determining a specified quality relationship, a corresponding version-specific computing task is determined and enabled for execution at step 210 upon determining a particular version hierarchy.

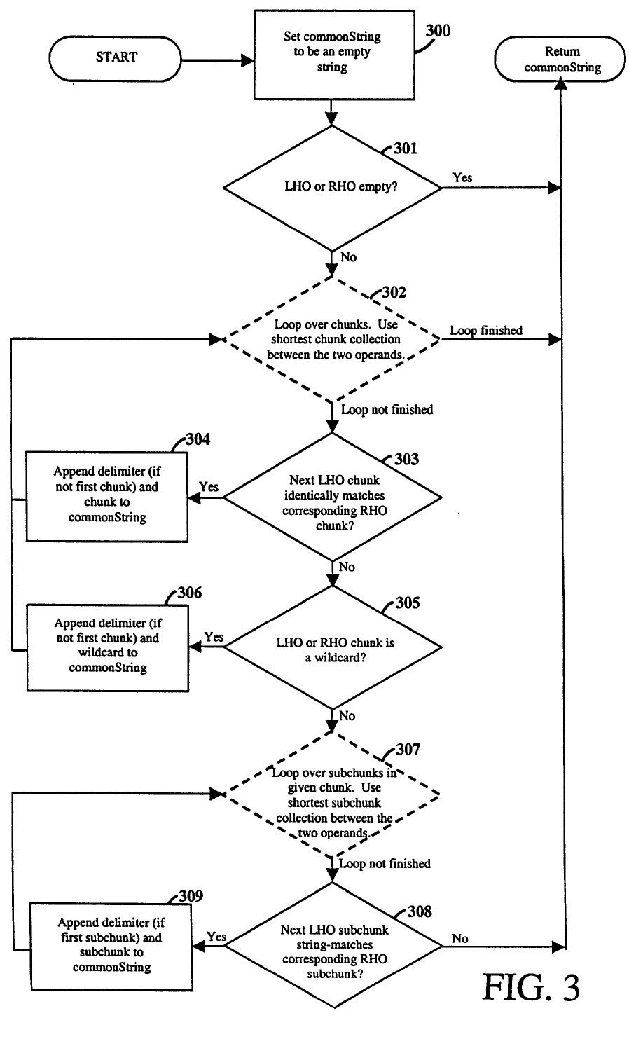

FIG. 3 illustrates an exemplary commonality method of the present invention for determining what is common between two version strings, i.e. version commonality is the specified quality relationship. The intent of such functionality is to assist developers in matching version strings to a chosen “depth”, i.e. a chosen number of chunks as read from left to right. The result of invoking the commonality method is typically a commonString which is a new version string containing the chunks and subchunks which are common to the LHO and RHO. The original set of delimiters found in the LHO is reinserted between the chunks in the order in which they occurred in the LHO. Some examples of invoking the common method of the present invention are shown in Table 2.

TABLE 2

a) “1.2.3” and “1.2” returns “1.2”
b) “2.1” and “1.2” returns “”
c) “2.1.x” and “2.1” returns “2.1”
d) “2.1.1.x” and “2.x.1.4.7.6” returns “2.x.1.x”
3) “1.2-b13” and “1.2-b14” returns “1.2-b”

As can be seen in FIG. 3, an exemplary embodiment of the common method begins by declaring a commonString to be empty at step 300. If either the LHO or RHO is empty at step 301, then an empty commonString is returned, indicating that there is no commonality. After this point both version strings are known to be populated. The same-order string chunk pairs are now processed for matching until exhausted, or until a non-matching same-order string chunk is found. A loop is initialized at step 302 to iterate over the chunks, up to the number of times as the smallest chunk collection between the two parsed version string operands, i.e. the iteration continues for all same-order string chunk pair. If the loop is allowed to finish, the commonString is returned, and no subchunks are considered. Iterating up to the smallest chunk collection ensures that only same-order chunk pairs are considered. If the LHO and corresponding RHO same-order chunks pointed to by the iteration identically match for a case-insensitive ASCII comparison at 303 then the common string chunk is appended to the commonString at step 304. If this was not the first chunk processed, then the original delimiter precedes the appended common chunk. The loop then advances to its next iteration. If the chunks do not identically match at step 303, then both operands are checked to see if either is a wildcard at 305 for wildcard or variable matching. If so, the wildard is appended to the commonString at 306. Again, if this is not the first chunk processed, then the original delimiter precedes the appended wildcard. It is intuitive to add the wildcard to the commonString when it is used in a match, because the wildcard can represent the chunk value, but the chunk value cannot represent the wildcard. Since (as previously mentioned) the iteratative comparison continues over the smaller collection of chunks, then the commonality of a LHO such as “2.1.x” and a RHO such as “2.1” would be “2.1”, and not “2.1.x”.

If neither chunk is a wildcard at step 305, then an inner loop is initialized at 307 to iterate over the chunk's subchunks, up to the number of times as the smallest subchunk collection between the LHO's chunk and RHO's chunk referred to by the iteration of the outermost loop 302, i.e. for all same-order string subchunks. In this way, it is determined how much of the chunk is common and therefore added to the commonString. As previously shown in the examples, a LHO such as “1.2-b13” and a RHO such as “1.2-b14” returns “1.2-b”. Recalling that subchunks are always split along decimal, alpha, and symbol boundaries, the erroneous result of “1.2-b1” would not occur. If the LHO chunk's subchunk and corresponding RHO chunk's subchunk identically match for a case-insensitive ASCII comparison 308, then the matching subchunk is appended to the commonString. If this is the first subchunk appended, then the original delimiter is appended in front of the subchunk. This loop never exhausts its potential number of iterations because not all the subchunks will match, or else this loop would not have been entered into in the first place (i.e. the string chunks would have matched).

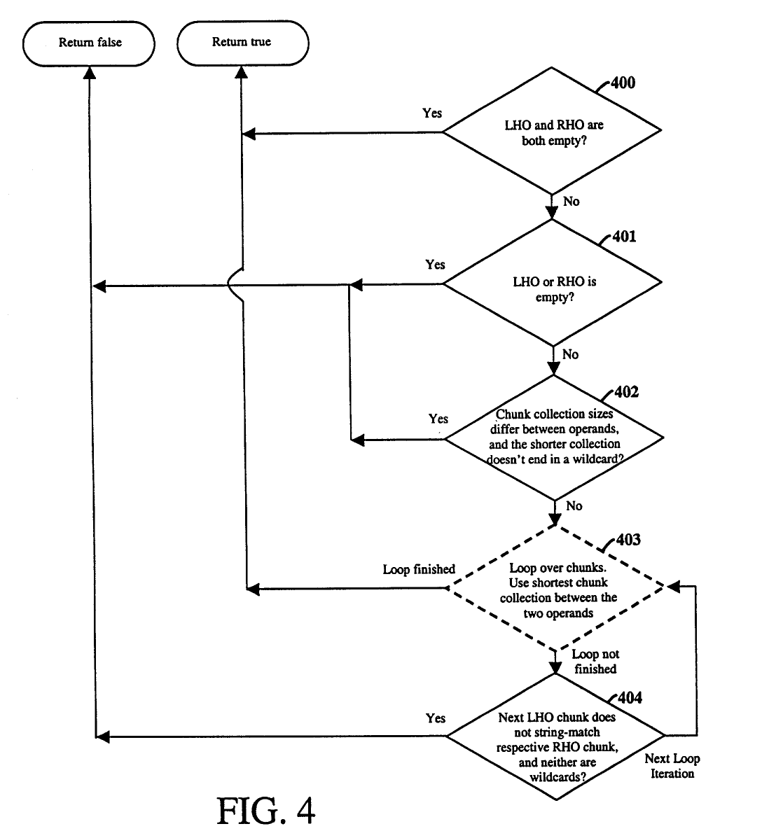

FIG. 4 illustrates an exemplary matches method for determining if two version strings are equivalent, i.e. version equivalence is the specified quality relationship. Given a LHO and RHO, the method returns a Boolean, i.e. true or false. Examples of invoking the matches method are shown in Table 3:

TABLE 3

a) “1.0” and “1.0” returns true
b) “1.0-3b12” and “1.0-3b12” returns true
c) “1.0a” and “1.0” returns false
d) “1.x” and “1” returns false
e) “1.x” and “1.0” returns true
f) “1.x” and “1.0.1” returns true

The method begins by determining if both the LHO and RHO are empty at 400, and if so, returns true. If then only one of the two is empty at 401, it returns false. Trailing wildcards in one operand match any number of corresponding trailing chunks in the other operand. For example “3.x” matches “3.beta7.2”. In light of this, if the LHO and RHO chunk collection sizes differ, and the shorter collection doesn't end in a wildcard 402, then false is returned. The chunks are now processed for matching until exhausted, or until a same-order pair is found to be mismatching. A loop is initialized at step 403 to iterate over the chunks, up to the number of times as the smallest chunk collection between LHO and the RHO. If the LHO and corresponding RHO same-order chunks pointed to by the iteration do not match for a case-insensitive ASCII comparison, and neither are wildcards at 404, then false is returned. Otherwise, the loop is continued. Clearly, no subchunks are ever considered in this method.

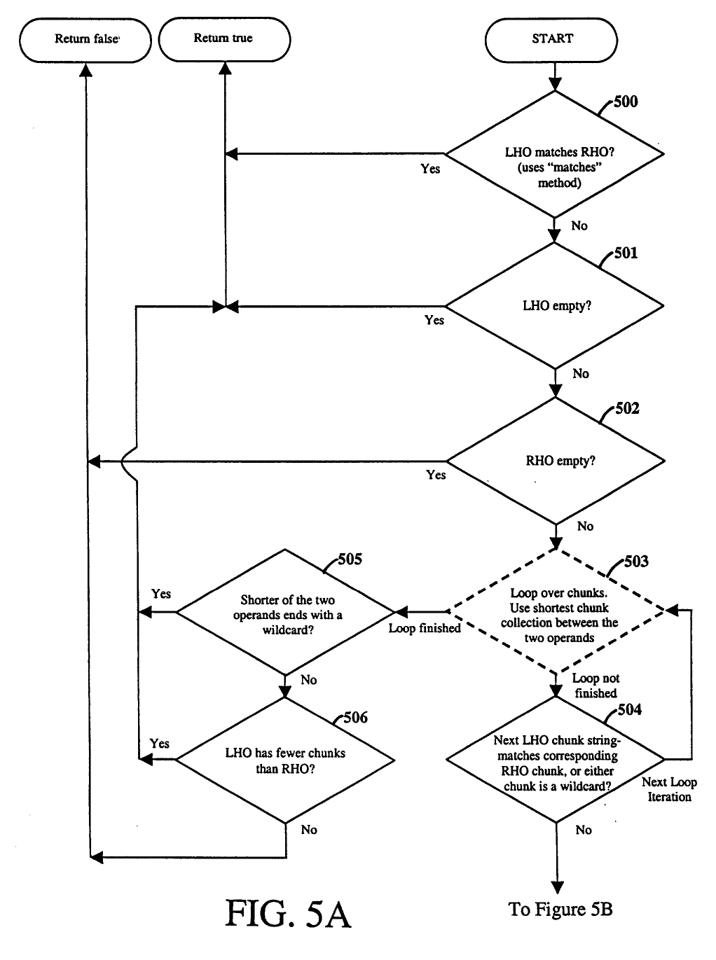

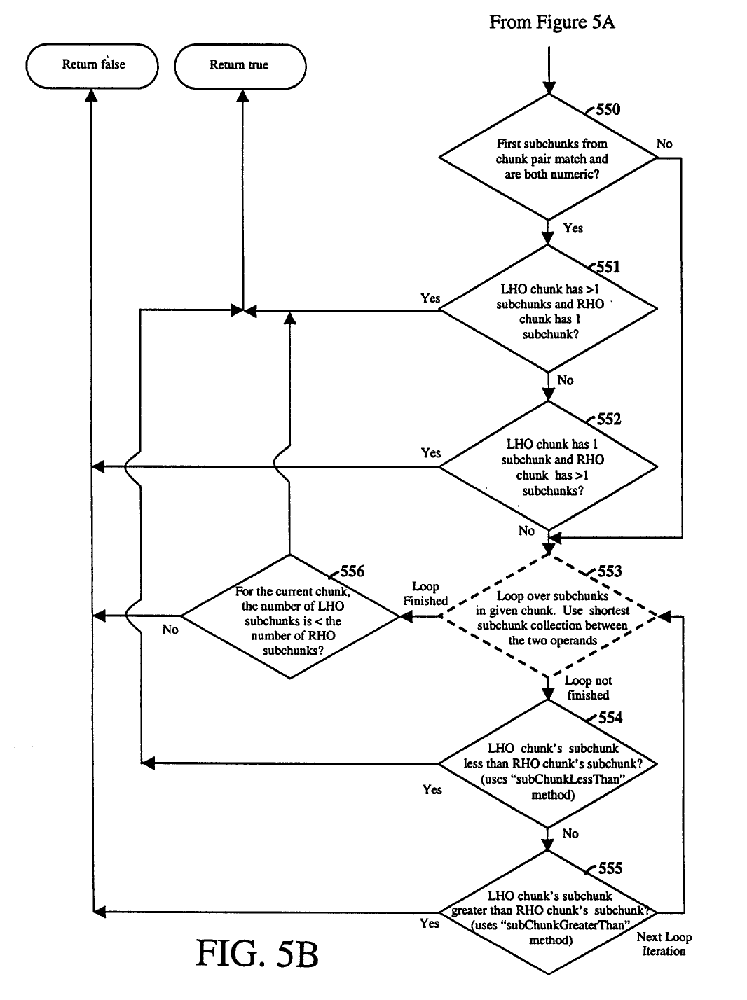

FIGS. 5A and 5B illustrate an exemplary lessThanOrEqual method for determining if the LHO is less-than-or-equal to the RHO, i.e. less-than-or-equal version inequality is the specified quality relationship. Given a LHO and RHO, the method returns a Boolean, i.e. true or false. Note that it is not possible to create a corresponding lessThan method for comparing string chunks, since it can not be known in the general case how a wildcard (i.e. a chunk variable) should be measured against a fixed value (e.g. for x not equal to 3, is x less than 3, or greater than 3?). Examples of invoking the lessThanOrEqual method are shown in Table 4:

TABLE 4

a) “5.a12” ≦ “5.a9” returns false
b) “1.05” ≦ “1.4” returns true
c) “1.beta” ≦ “1.1” returns true
d) “3.x” ≦ “3.1” returns true
e) “3.1” ≦ “3.x” returns true
f) “3” ≦ “3.x” returns true
g) “3.x” ≦ “3” returns false

The method begins by checking if the LHO matches the RHO using the matches method 500, and if so, returns true. If the LHO is an empty string at step 501, then true is returned. Conversely, if the RHO is an empty string at 502 (and we know LHO is not), then false is returned. The chunks are now processed by initializing a loop at 503 to iterate over the chunks, up to the number of times as the smallest chunk collection between the LHO and RHO, i.e. all same-order string chunks. If the loop is allowed to terminate (meaning it has fully iterated over the smallest of the two chunk collections) then two more checks are made. If the shorter of the two operands ends with a wildcard at 505, then true is returned (because versions like “3.x” are considered equivalent to versions such as “3.1.4.4”). If the LHO has fewer chunks than the RHO at 506 then true is returned, else false is returned. This is expected because “3.1” which has fewer chunks should be less than “3.1.1”. While the loop at step 503 is in progress, pairs of chunks are compared. If the string chunk pairs identically match or if either is a wildcard at 504, the loop advances to its next iteration. If the chunk pair does not match (identical or variable), then the attention turns to subchunk comparisons to determine a less-than relationship.

An unfortunate, but accepted practice by companies that assign version strings is the practice of appending an alpha subchunk to a pair of otherwise simple numerically matching subchunks to indicate a previous version. For example “3.1” should intuitively be less than “3.1a”, but usually companies mean just the opposite, and are implying that the “a” is an alpha version completed prior to the official version. This special case handling is consistent with the ordering intended by the previously mentioned 3693 version strings (with their associated vendors and product names) that have comprised the bulk of the test data for this methodology. This functionality begins by checking if the first subchunk for both the RHO and LHO chunks are matching and are both numeric. If not, the method advances to step 553. If the LHO chunk has more than one subchunk but the RHO only had one subchunk at 551, then true is returned. Conversely, if the LHO chunk has one subchunk but the RHO has more than one subchunk at 552, then false is returned. If the previously explained functionality is not desired, it may be overridden by simply skipping over steps 550 through 552, allowing the flow of logic to proceed from 504 to 553 directly. Again, this would probably be implemented on a vendor/product name pair basis as needed.

Next, an inner loop in initialized at step 553 to iterate over the chunk pair's subchunks, up to the number of times as the smallest subchunk collection referred to by the iteration of the outermost loop at 503. If by using the subChunkLessThan method it is determined that the LHO's chunk's subchunk is less than the RHO's chunk's subchunk at 554, then true is returned. Conversely, if by using the subChunkGreaterThan method it is determined that the LHO's chunk's subchunk is greater than the RHO's chunk's subchunk at 555, then false is returned, otherwise the method advances to the next iteration of the loop at 553. If the loop finishes, then a determination is made whether, for the current chunk pair being compared, the number of subchunks from the LHO's chunks is fewer than the number subchunks from the RHO's chunk at 556. If so, the true is returned, and if not, false is returned. This produces an intuitive result in that, for example, a LHO such as “3.1a” should be less than a RHO such as “3.1a5”.

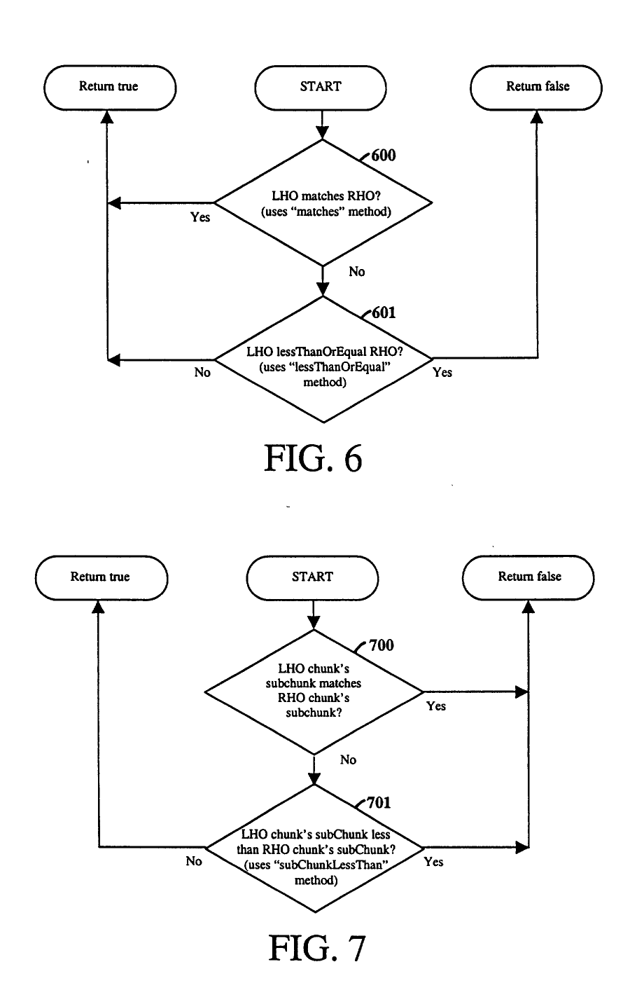

FIG. 6 illustrates an exemplary greaterThanOrEqual method for determining if the LHO is greater-than-or-equal to the RHO, i.e. greater-than-or-equal version inequality is the specified quality relationship to be determined. Given a LHO and RHO, the method returns a Boolean of true or false. The method starts by employing the matches method to check if the LHO matches the RHO at step 600, and returns true if they do. If, by invoking the lessThanOrEqual method, the LHO is determined to be less than or equal to the RHO at 601, then false is returned, otherwise, true is returned.

FIG. 7 illustrates an exemplary subChunkGreaterThan method for determining if a LHO chunk's subchunk is greater than its corresponding RHO chunk's subchunk. This method is not invoked directly, but rather supports the lessThanOrEqual method. Given two subchunks, the subChunkGreaterThan method returns a Boolean. The method starts by checking if the given LHO chunk's subchunk matches the given RHO's chunk's subchunk for a case-insensitive ASCII comparison at step 700, and if so, returns false. If, by invoking the subChunkLessThan method, the LHO chunk's subchunk is found to be less than the RHO chunk's subchunk at 701, then false is returned, otherwise true is returned.

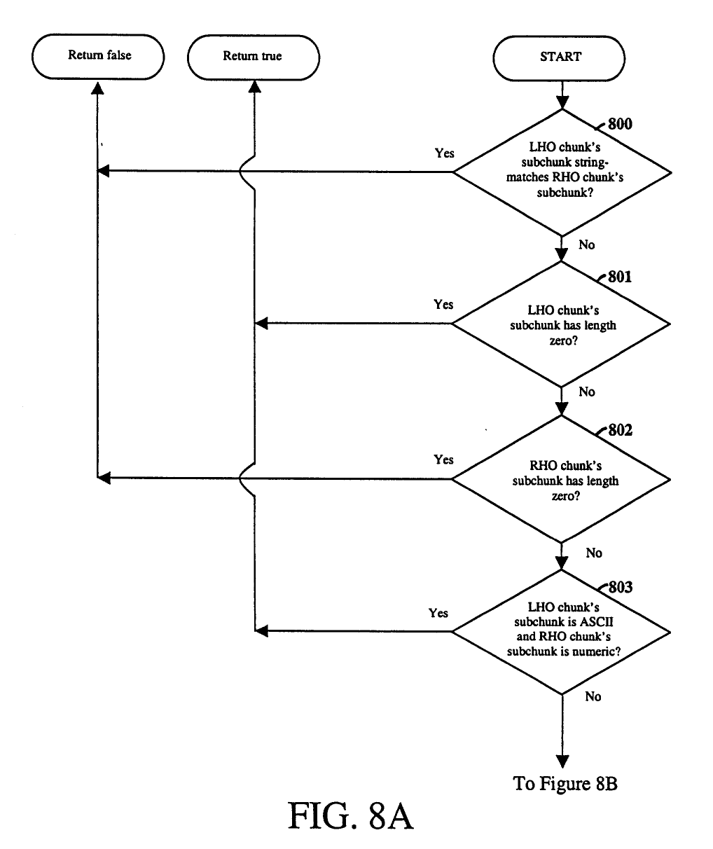

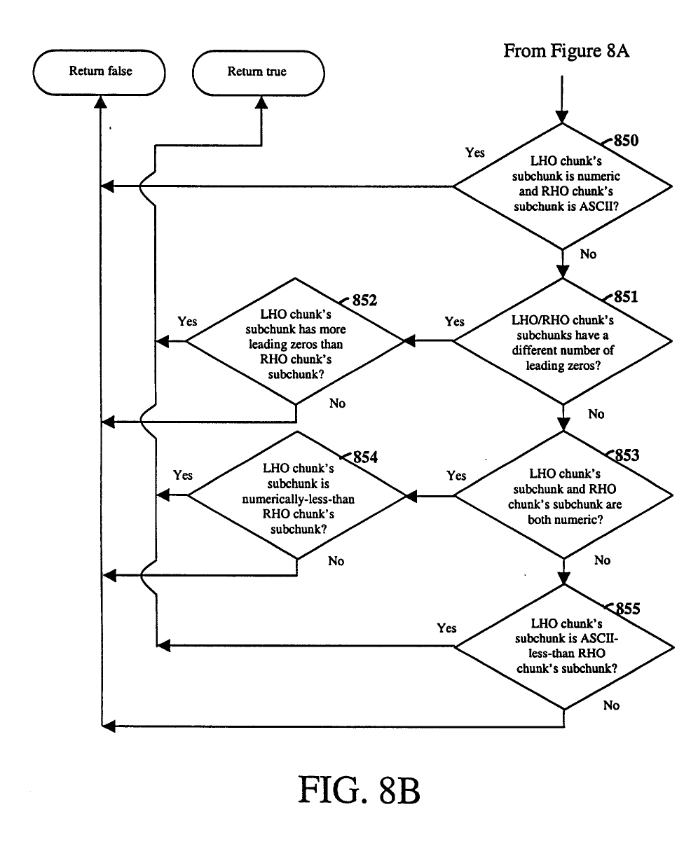

FIGS. 8A and 8B illustrate an exemplary subChunkLessThan method for determining if a LHO chunk's subchunk is less than its corresponding RHO chunk's subchunk. This method is not invoked directly, but rather supports the lessThanOrEqual and subChunkGreaterThan methods discussed previously. Given two subchunks the subChunkessThan method returns a Boolean. The method starts by determining if the pair of subchunks satisfy a case-insensitive ASCII match at step 800, and if so returns false. If only the LHO chunk's subchunk has a length of zero at 801, then true is returned. Conversely, if only the RHO chunk's subchunk has a length of zero at 802, then false is returned. The method asserts that alpha subchunks are less than numerical subchunks, which appropriately results in a LHO such as “3.b5” hierarchically ordered as being less than or equal to a RHO such as “3.5b”. To these ends, if the LHO chunk's subchunk is numeric 803, then true is returned. Conversely, if the LHO chunk's subchunk is numeric, and the RHO chunk's subchunk is alpha at 850, then false is returned. Additionally, the method asserts that numerical subchunks with leading zeros are less than other numerical subchunks that have fewer leading zeros. For example, “3.05” less than “3.4” should satisfy one's intuition (even though “05” less than “4” would normally fail a simple numeric ordering). Therefore, if the LHO chunk's subchunk and RHO chunk's subchunk are both numeric and both have a different number of leading zeros at 851 then the LHO chunk's subchunk is checked at 852 to determine if it has a greater number of leading zeros than the RHO chunk's subchunk. If so then true is returned, and if not false is returned. If in the unlikely event that the previously explained functionalities are not desired, such functionalities can be overridden by simply skipping over the relevant steps. For example, skipping steps 803 and 850 allows the flow of logic to proceed from 802 to 851 directly. Similarly, skipping over steps 851 and 852 allows the flow of logic to proceed from 850 to 853 directly.

The method asserts that a pair of numerical subchunks (without leading zeros) are to be compared numerically. For example, a LHO of “3.9” is less than a RHO of “3.15”, given that a numerical ordering would find 9 less than 15. (Note that this would fail an ASCII ordering because the character “1” precedes the character “9”. To these ends, the method checks if the LHO chunk's subchunk and RHO chunk's subchunk are both numeric 853. If so, then the LHO chunk's subchunk is checked to see if it is numerically less than the RHO chunk's subchunk 854. If so, true is returned, if not, false is returned. If the previously explained functionality is not desired (i.e. if you needed ASCII ordering for numerical subchunks), it may be overridden by simply skipping over steps 853 and 854, allowing the flow of logic to proceed from 851 to 855 directly. One reason for favoring such an override occurs when considering Netscape Communicator software versioning schemes. In a manner that violates conventional versioning schemes, Netscape Communicator “4.6” is followed by “4.61”, then followed again by version “4.7”. A numerical order would sort to “4.6”, “4.7” and “4.61”, which in this case is not chronological. An override is required in this case for all versions associated with the vendor Netscape and the software package Communicator. If the two subchunks are not numeric 853, then the two subchunks are compared in an ASCII ordering 855 to determine if the LHO chunk's subchunk is less than the RHO chunk's subchunk. If so, then true is returned, and if not, false returned.

There are at least four areas that are impacted by the (up until now) non-automatic process of comparing version strings, and which stand to benefit from the algorithm of the present invention: Active security scanner software, passive security scanner software, compliance auditing software, and system hardening software. Application of the present invention for each of these computing applications typically requires that a test version string be compared against a designated reference version string, to determine the standing of the test version string relative to the reference version string. Furthermore, each of the aforementioned applications establish a version-specific computing task for which execution depends on the results of the version comparison.

In one exemplary embodiment of the present invention, the algorithm is implemented in an active security scanner software which actively probes machines on networks to determine if security vulnerabilities exist. This is frequently done by examining the version strings associated with operating systems, software, system patches, and firmware. A vulnerability often applies to a particular component type and version, and additionally all pervious versions of that component (ex: vulnerability in Netscape Communicator 4.x and earlier). Because version strings are semi-structured, this vulnerability mapping has typically been done by hand by enumerating all versions prior to that version number, which is both tedious, and error prone. However, the present invention for comparing version strings enables such a version comparison and subsequent vulnerability mapping to be made automatically in a rule based fashion, even with very complicated semi-structured version strings.

In a similar exemplary embodiment, the algorithm of the present invention is utilized for passive security scanner software. Semi-structured version comparison problems become even more difficult with passive security scanner software because this kind of software must observe its domain (generally network traffic) by listening only, and without interrogating it directly. Consequentially, the version information is even more semi-structured, as information is likely to be incomplete. For example, a passive network observation may discover some version 2 of Redhat Linux. The most that can be determined would be Redhat Linux version “2.x”. This increases the need for rule based comparisons, as wild cards (the “x”) complicate equality/inequality handling. The rules provided and implemented as per the present invention allow for automatic version-specific decision making that was not previously possible, and will become increasingly important to projects related to homeland security.

Compliance auditing software scans networks to assist auditors in their task of assuring that the software licensing agreements are being adhered to, with respect to number of software package installs, as well as usage patterns (i.e. metered software). Ranges of software versions are often covered under one license, but not another. Therefore, comparisons of semi-structured version strings provided by the algorithm of the present invention serve to provide version-specific notification of compliance. Without automated comparisons, every possible match must be enumerated by the developers creating the auditing software, which is again, tedious, error prone, and goes out of date more quickly than rule based comparisons described in the present invention.

And in another exemplary embodiment of the present invention, the algorithm is utilized in system hardening software which is generally run by system administrators to detect vulnerable software on a specific system (as opposed to a network scan) to determine the necessity for upgrading. Application of the present invention to system hardening applications serve to automatically install updates to make the system more secure against the constant stream of publicly released vulnerabilities (over 140 per month on average). As the version-specific computing task, auto-installation of an upgraded version, is dependent on the outcome of the version string comparison of the present invention.

While four contexts are discussed above to illustrate the application and utility of the algorithm of the present invention, the algorithm is not limited only to such applications. Rather the algorithm may be utilized as an integral component of any application or context in which version-specific tasks are to be performed with respect to computer code, and the code version must be first identified and/or sequenced relative to other versions thereof.

Furthermore, while particular operational sequences, parameters, and particular embodiments have been described and or illustrated, such are not intended to be limiting. Modifications and changes may become apparent to those skilled in the art, and it is intended that the invention be limited only by the scope of the appended claims.

I claim:

1. A method of comparing version strings in a computing environment for enabling version-specific computing tasks, the method comprising:
dividing each of a first and a second version string at each one of a set of predetermined delimiters to produce respective first and second sets of sequentially ordered string chunks;
iteratively comparing string chunks of the same order to determine if matching therebetween, wherein the comparison of same-order string chunks continues until a non-matching same-order string chunk pair is encountered; and
determining that a specified quality relationship exists between the first and second version strings only if the matching comparisons satisfy a set of predetermined matching/non-matching conditions thereof, wherein the specified quality relationship determines execution of a version-specific computing task.

2. The method as in claim 1,
wherein a same-order string chunk pair is determined to match if at least one string chunk of the same-order string chunk pair consists of a wildcard.

3. The method as in claim 1,
wherein the comparison of same-order string chunks occurs in increasing sequential chunk order from left to right starting with first order string chunks.

4. The method as in claim 1,
further comprising, upon encountering a non-matching same-order string chunk pair:
dividing each string chunk of the non-matching same-order string chunk pair into a corresponding set of sequentially ordered string subchunks based on predetermined subchunk categories, with each string subchunk comprising adjacent string elements of the same subchunk category; and
iteratively comparing string subchunks of the same order from the non-matching same-order string chunk pair to determine if matching therebetween, wherein the comparison of same-order string subchunks continues until a non-matching same-order string subchunk pair is encountered.

5. The method as in claim 4,
wherein the comparison of same-order string subchunks in the non-matching same-order string chunk pair occurs in increasing sequential subchunk order from left to right starting with first order string subchunks thereof.

6. The method as in claim 4,
further comprising, upon encountering a non-matching same-order string subchunk pair, determining that an alpha string subchunk is less than a numeric string subchunk.

7. The method as in claim 4,
further comprising, upon encountering a non-matching same-order string subchunk pair, determining that a numeric string subchunk with a greater number of leading zeros is less than a numeric string subchunk with fewer leading zeros.

8. The method as in claim 1,
wherein the comparison of same-order string chunks is a case insensitive ASCII comparison.

9. The method as in claim 1,
further comprising comparing corresponding delimiters in the first and second version strings to determine if matching therebetween.

10. The method as in claim 1,
wherein version commonality is the specified quality relationship to be determined between the first and second version strings, with the set of predetermined matching/non-matching conditions including a determination that at least one same-order string component pair matches.

11. The method as in claim 10,
further comprising, for each determination that a same-order string chunk pair matches, appending the string chunk to a commonString.

12. The method as in claim 11,
wherein a same-order string chunk pair is determined to match if at least one string chunk of the same-order string chunk pair consists of a wildcard, and the wildcard is appended to the commonString.

13. The method as in claim 10,
further comprising, upon encountering a non-matching same-order string chunk pair:
dividing each string chunk of the non-matching same-order string chunk pair into a corresponding set of sequentially ordered string subchunks based on predetermined subchunk categories, with each string subchunk comprising adjacent string elements of the same subchunk category;
iteratively comparing string subchunks of the same order from the non-matching same-order string chunk pair to determine if matching therebetween, wherein the comparison of same-order string chunks continues until a non-matching same-order string chunk pair is encountered; and
for each determination that a same-order string subchunk pair matches, appending the string subchunk to a commonString.

14. The method as in claim 1,
wherein version equivalence is the specified quality relationship to be determined between the first and second version strings, with the set of predetermined matching/non-matching conditions including a determination that all same-order string chunks match.

15. The method as in claim 14,
wherein, for first and second version strings having respective first and second chunk sets with an equal number of string chunks, the set of predetermined matching/non-matching conditions consists only of the determination that all same-order string chunks match.

16. The method as in claim 14,
wherein a same-order string chunk pair is determined to match if at least one string chunk of the same-order string chunk pair consists of a wildcard.

17. The method as in claim 16,
wherein, for first and second version strings having first and second chunk sets with a different number of string chunks, the set of predetermined matching/non-matching conditions further includes a determination that a trailing wildcard is present in a smaller one of the first and second chunk sets.

18. The method as in claim 1,
wherein the specified quality relationship to be determined is whether the first version string is less-than-or equal-to the second version string, said determination including an initial determination of version equivalence and, upon encountering a non-matching same-order string chunk, a subsequent determination of less-than type version inequality.

19. The method as in claim 18,
wherein the less-than type version inequality determination includes:
dividing each string chunk of the non-matching same-order string chunk pair into a corresponding set of sequentially ordered string subchunks based on predetermined subchunk categories, with each string subchunk comprising adjacent string elements of the same subchunk category, and
iteratively comparing string subchunks of the same order from the non-matching same-order string chunk pair to determine if matching therebetween, wherein the comparison of same order string subchunks continues until a non-matching same-order string subchunk pair is encountered.

20. The method as in claim 19,
wherein the set of predetermined matching/non-matching conditions includes a determination that, upon encountering a non-matching same-order string subchunk pair, the string subchunk of the first version string is from an alpha subchunk category and the same-order string subchunk of the second version string is from a numeric subchunk category.

21. The method as in claim 19,
wherein the set of predetermined matching/non-matching conditions includes a determination that each string subchunk of the non-matching string subchunk pair is from a numeric subchunk category and the string subchunk of the first version string has a greater number of leading zeros than the same-order string subchunk of the second version string.

22. The method as in claim 1,
wherein the specified quality relationship to be determined is whether the first version string is greater-than-or equal-to the second version string, said determination including an initial determination of version equivalence and, upon encountering a non-matching same-order string chunk, a subsequent determination of greater-than type version inequality.

23. The method as in claim 22,
wherein the greater-than type version inequality determination includes:
dividing each string chunk of the non-matching same-order string chunk pair into a corresponding set of sequentially ordered string subchunks based on predetermined subchunk categories, with each string subchunk comprising adjacent string elements of the same subchunk category, and
iteratively comparing string subchunks of the same order from the non-matching same-order string chunk pair to determine if matching therebetween, wherein the comparison of same order string subchunks continues until a non-matching same-order string subchunk pair is encountered.

24. The method as in claim 23,
wherein the set of predetermined matching/non-matching conditions includes a determination that the string subchunk of the first version string is from a numeric subchunk category and the same-order string subchunk of the second version string is from an alpha subchunk category.

25. The method as in claim 23,
wherein the set of predetermined matching/non-matching conditions includes a determination that each string subchunk of the non-matching string subchunk pair is from a numeric subchunk category and the string subchunk of the first version string has a lesser number of leading zeros than the same-order string subchunk of the second version string.

26. A method of determining, in a computing environment, version hierarchy between version strings for enabling version-specific computing tasks, the method comprising:
designating a reference version string against which version string comparisons may be made;
identifying a test version string associated with a test version of a computer device in the computing environment;
dividing each of the test and reference version strings at each one of a set of predetermined delimiters to produce respective test and reference sets of sequentially ordered string chunks;
iteratively comparing string chunks of the same order to determine if matching therebetween, wherein the comparison of same-order string chunks continues until a non-matching same-order string chunk pair is encountered; and
determining version hierarchy between the first and second version strings from the matching comparisons and in accordance with a set of predetermined matching/non-matching conditions, wherein the version hierarchy determines execution of a version-specific computing task.

27. The method as in claim 26,
wherein the determination of version hierarchy includes determining from the matching comparisons that the test version string is equal to the reference version string if, for test and reference version strings having respective test and reference chunk sets with an equal number of string chunks, all same-order string chunks match.

28. The method as in claim 26,
wherein the determination of version hierarchy includes determining from the matching comparisons that the test version string is equal to the reference version string if, for test and reference version strings having respective test and reference chunk sets with a different number of string chunks, all same-order string chunks match and a trailing wildcard is present in a smaller one of the test and reference chunk sets.

29. The method as in claim 26,
further comprising, upon determining non-equality between the test and reference version strings by encountering a non-matching same-order string chunk pair:
dividing each string chunk of the non-matching same-order string chunk pair into a corresponding set of sequentially ordered string subchunks based on predetermined subchunk categories, with each string subchunk comprising adjacent string elements of the same subchunk category; and
iteratively comparing string subchunks of the same order from the non-matching same-order string chunk pair to determine matching therebetween, wherein the comparison of same-order string subchunks continues until a non-matching same-order string subchunk pair is encountered.

30. The method as in claim 29,
wherein the determination of version hierarchy includes, upon encountering a non-matching same-order string subchunk pair from the matching comparisons, determining that the test version string is less than the reference version string if in the non-matching same-order string subchunk pair an alpha string subchunk is associated with the test version string and a numeric string subchunk is associated with the reference version string.

31. The method as in claim 29,
wherein the determination of version hierarchy includes, upon encountering a non-matching same-order string subchunk pair from the matching comparisons, determining that the test version string is less than the reference version string if in the non-matching same-order string subchunk pair both the test and reference version strings include numeric string subchunks, with the numeric string subchunk associated with the test version string having a greater number of leading zeros than the numeric string subchunk associated with the reference version string.

32. The method as in claim 29,
wherein the determination of version hierarchy includes, upon encountering a non-matching same-order string subchunk pair from the matching comparisons, determining that the test version string is greater than the reference version string if in the non-matching same-order string subchunk pair a numeric string subchunk is associated with the test version string and an alpha string subchunk is associated with the reference version string.

33. The method as in claim 29,
wherein the determination of version hierarchy includes, upon encountering a non-matching same-order string subchunk pair from the matching comparisons, determining that the test version string is greater than the reference version string if in the non-matching same-order string subchunk both the test and reference version strings include numeric string subchunks, with the numeric string subchunk associated with the reference version string having a greater number of leading zeros than the numeric string subchunk associated with the test version string.

34. A computer system for comparing version strings for use in enabling version-specific computing tasks, the computer system comprising:
a first module that divides each of a first and a second version string at each one of a set of predetermined delimiters to produce respective first and second sets of sequentially ordered string chunks;
a second module that iteratively compares string chunks of the same order to determine if matching therebetween, wherein the comparison of same-order string chunks continues until a non-matching same-order string chunk pair is encountered; and
a third module that determines that a specified quality relationship exists between the first and second version strings only if the matching comparisons satisfy a set of predetermined matching/non-matching conditions thereof, wherein the specified quality relationship determines execution of a version-specific computing task.

35. The computer system as in claim 34, further comprising:
a fourth module that, upon the encounter of a non-matching same-order string chunk pair, divides each string chunk of the non-matching same-order string chunk pair into a corresponding set of sequentially ordered string subchunks based on predetermined subchunk categories, with each string subchunk comprising adjacent string elements of the same subchunk category; and
a fifth module that iteratively compares string subchunks of the same order from the non-matching same-order string chunk pair to determine if matching therebetween, wherein the comparison of same-order string subchunks continues until a non-matching same-order string subchunk pair is encountered.

36. The computer system as in claim 35, further comprising:
a sixth module that determines, upon the encounter of a non-matching same-order string subchunk pair, that an alpha string subchunk is less than a numeric string subchunk.

37. The computer system as in claim 35, further comprising:
a seventh module that determines, upon the encounter of a non-matching same-order string subchunk pair, that a numeric string subchunk with a greater number of leading zeros is less than a numeric string subchunk with fewer leading zeros.

38. A computer system for determining version hierarchy between version strings for use in version-specific computing tasks, the computer system comprising:
a first module that designates a reference version string against which version string comparisons may be made;
a second module that identifies a test version string associated with a test version of a computer device in a computing environment;
a third module that divides each of the test and reference version strings at each one of a set of predetermined delimiters to produce respective test and reference sets of sequentially ordered string chunks;
a fourth module that iteratively compares string chunks of the same order to determine if matching therebetween, wherein the comparison of same-order string chunks continues until a non-matching same-order string chunk pair is encountered; and
a fifth module that determines a version hierarchy between the first and second version strings from the matching comparisons and in accordance with a set of predetermined matching/non-matching conditions, wherein the version hierarchy determines execution of a version-specific computing task on the test version of the computer device.

39. The computer system as in claim 38,
wherein the fifth module includes a sixth module that determines from the matching comparisons that the test version string is equal to the reference version string if, for test and reference version strings having respective test and reference chunk sets with an equal number of string chunks, all same-order string chunks match.

40. The computer system as in claim 38,
wherein the fifth module includes a seventh module that determines from the matching comparisons that the test version string is equal to the reference version string if, for first and second version strings having first and second chunk sets with a different number of string chunks, all same-order string chunks match and a trailing wildcard is present in a smaller one of the first and second chunk sets.

41. The computer system as in claim 38, further comprising:
an eighth module that, upon a determination of non-equality between the test and reference version strings by the encounter of a non-matching same-order string chunk corresponding set of sequentially ordered string subchunks based on predetermined subchunk categories, with each string subchunk comprising adjacent string elements of the same subchunk category; and
a ninth module that iteratively compares string subchunks of the same order from the non-matching same-order string chunk pair to determine matching therebetween, wherein the comparison of same-order string subchunks continues until a non-matching same-order string subchunk pair is encountered.

42. The computer system as in claim 41,
wherein the fifth module includes a tenth module that, upon encountering a non-matching same-order string subchunk pair from the matching comparisons, determines that the test version string is less than the reference version string if in the non-matching same-order string subchunk pair an alpha string subchunk is associated with the test version string and a numeric string subchunk is associated with the reference version string.

43. The computer system as in claim 41,
wherein the fifth module includes an eleventh module that, upon encountering a non-matching same-order string subchunk pair from the matching comparisons, determines that the test version string is less than the reference version string if in the non-matching same-order string subchunk pair both the test and reference version strings include numeric string subchunks, with the numeric string subchunk associated with the test version string having a greater number of leading zeros than the numeric string subchunk associated with the reference version string.

44. The computer system as in claim 41,
wherein the fifth module includes a twelfth module that, upon encountering a non-matching same-order string subchunk pair from the matching comparisons, determines that the test version string is greater than the reference version string if in the non-matching same-order string subchunk pair an alpha string subchunk is associated with the test version string and a numeric string subchunk is associated with the reference version string.

45. The computer system as in claim 41,
wherein the fifth module includes a thirteenth module that, upon encountering a non-matching same-order string subchunk pair from the matching comparisons, determines that the test version string is greater than the reference version string if in the non-matching same-order string subchunk both the test and reference version strings include numeric string subchunks, with the numeric version string associated with the test version string having a greater number of leading zeros than the numeric string subchunk associated with the reference version string.

46. A computer program product comprising:
a computer usable medium and computer readable code embodied thereon for comparing version strings to enable version-specific computing task, the computer readable code comprising:
computer readable program code means for causing a computer to divide each of a first and a second version string at each one of a set of predetermined delimiters to produce respective first and second sets of sequentially ordered string chunks;
computer readable program code means for causing the computer to iteratively compare string chunks of the same order to determine if matching therebetween, wherein the comparison of same-order string chunks continues until a non-matching same-order string chunk pair is encountered; and
computer readable program code means for causing the computer determine that a specified quality relationship exists between the first and second version strings if the matching comparisons satisfy a set of predetermined matching/non-matching conditions, wherein the specified quality relationship determines execution of the version-specific computing task.

47. The computer program product as in claim 46, further comprising:
computer readable program code means for causing the computer, upon the encounter of a non-matching same-order string chunk pair, to divide each string chunk of the non-matching same-order string chunk pair into a corresponding set of sequentially ordered string subchunks based on predetermined subchunk categories, with each string subchunk comprising adjacent string elements of the same subchunk category; and
computer readable program code means for causing the computer to iteratively compare string subchunks of the same order from the non-matching same-order string chunk pair to determine if matching therebetween, wherein the comparison of same-order string chunks continues until a non-matching same-order string chunk pair is encountered.

48. The computer program product as in claim 47, further comprising:
computer readable program code means for causing the computer, upon the encounter of a non-matching same-order string subchunk pair, to determine that an alpha string subchunk is less than a numeric string subchunk.

49. The computer program product as in claim 47, further comprising:
computer readable program code means for causing the computer, upon the encounter of a non-matching same-order string subchunk pair, to determine that a numeric string subchunk with a greater number of leading zeros is less than a numeric string subchunk with fewer leading zeros.

50. A computer program product comprising:
a computer usable medium and computer readable code embodied thereon for determining version hierarchy between version strings for enabling version-specific computing tasks, the computer readable code comprising:
computer readable program code means for causing a computer to designate a reference version string against which version string comparisons may be made; computer readable program code means for causing the computer to identify a test version string associated with a test version of a computer device;
computer readable program code means for causing the computer to divide each of the test and reference version strings at each one of a set of predetermined delimiters to produce respective test and reference sets of sequentially ordered string chunks;
computer readable program code means for causing the computer to iteratively compare string chunks of the same order to determine if matching therebetween, wherein the comparison of same-order string chunks continues until a non-matching same-order string chunk pair is encountered; and
computer readable program code means for causing the computer to determine a version hierarchy between the test and reference version strings from the matching comparisons and in accordance with a set of predetermined matching/non-matching conditions, wherein the version hierarchy determines execution of a version-specific computing task on the test version of the computer device.

51. The computer system as in claim 50,
wherein the computer readable program code means for causing the computer to determine a version hierarchy from the matching comparisons determines that the test version string is equal to the reference version string if, for test and reference version strings having respective test and reference chunk sets with an equal number of string chunks, all same-order string chunks match.

52. The computer system as in claim 50,
wherein the computer readable program code means for causing the computer to determine a version hierarchy from the matching comparisons determines that the test version string is equal to the reference version string if, for first and second version strings having first and second chunk sets with a different number of string chunks, all same-order string chunks match and a trailing wildcard is present in a smaller one of the first and second chunk sets.

53. The computer program product as in claim 50, further comprising:
computer readable program code means for causing the computer, upon a determination of non-equality between the test and reference version strings by the encounter of a non-matching same-order string chunk pair, to divide each string chunk of the non-matching same-order string chunk pair into a corresponding set of sequentially ordered string subchunks based on predetermined subchunk categories, with each string subchunk comprising adjacent string elements of the same subchunk category; and
computer readable program code means for causing the computer to iteratively compare string subchunks of the same order from the non-matching same-order string chunk pair to determine matching therebetween, wherein the comparison of same-order string chunks continues until a non-matching same-order string chunk pair is encountered.

54. The computer program product as in claim 53, further comprising:
computer readable program code means for causing the computer, upon encountering a non-matching same-order string chunk pair from the matching comparisons, to determine that the test version string is less than the reference version string if in the non-matching same-order string subchunk pair an alpha string subchunk is associated with the test version string and a numeric string subchunk is associated with the reference version string.

55. The computer program product as in claim 53, further comprising:
computer readable program code means for causing the computer, upon encountering a non-matching same-order string chunk pair from the matching comparisons, to determine that the test version string is less than the reference version string if in the non-matching same-order string subchunk pair both the test and reference version strings include numeric string subchunks, with the numeric string subchunk associated with the test version string having a greater number of leading zeros than the numeric string subchunk associated with the reference version string.

56. The computer program product as in claim 53, further comprising:
computer readable program code means for causing the computer, upon encountering a non-matching same-order string chunk pair from the matching comparisons, to determine that the test version string is greater than the reference version string if in the non-matching same-order string subchunk pair an alpha string subchunk is associated with the test version string and a numeric string subchunk is associated with the reference version string.

57. The computer program product as in claim 53, further comprising:
computer readable program code means for causing the computer, upon encountering a non-matching same-order string chunk pair from the matching comparisons, to determine that the test version string is greater than the reference version string if in the non-matching same-order string subchunk both the test and reference version strings include numeric string subchunks, with the numeric string subchunk associated with the test version string having a greater number of leading zeros than the numeric string subchunk associated with the reference version string.

58. A method of automatic version upgrading in a computing environment, the method comprising:
designating a reference version string representing a version string threshold for upgrading to a pre-selected version of a computer code;
detecting from the computing environment a test version string associated with a test version of the computer code;
dividing each of the test and reference version strings at each one of a set of predetermined delimiters to produce respective first and reference sets of sequentially ordered string chunks;
iteratively comparing string chunks of the same order to determine if matching therebetween, wherein the comparison of same-order string chunks continues until a non-matching same-order string chunk pair is encountered;
determining from the matching comparisons that a specified quality relationship exists between the test and reference version strings if the matching comparisons satisfy a set of predetermined matching/non-matching conditions, wherein the specified quality relationship determines propriety of upgrading the test version to the pre-selected version of the computer code; and
if proper, upgrading the test version to the pre-selected version of the computer code.

59. The method as in claim 59,
wherein the reference version string is a pre-selected version string associated with the pre-selected version of the computer code.

60. A method of determining license compliance in a computing environment, the method comprising:
designating a reference version string for use as a qualifier for determining compliance of a version of a computer code;
detecting from the computing environment a test version string associated with a test version of the computer code;
dividing each of the test and reference version strings at each one of a set of predetermined delimiters to produce respective test and reference sets of sequentially ordered string chunks;
iteratively comparing string chunks of the same order to determine if matching therebetween, wherein the comparison of same-order string chunks continues until a non-matching same-order string chunk pair is encountered; and
determining that a specified quality relationship exists between the test and reference version strings if the matching comparisons satisfy a set of predetermined matching/non-matching conditions, wherein the specified quality relationship determines compliance of the test version of the computer code.

61. A method of determining vulnerabilities in a computing environment associated with known versions of a computer code, the method comprising:
designating a reference version string for use in determining the presence of a vulnerability;
detecting from the computing environment a test version string associated with a test version of the computer code;
dividing each of the test and reference version strings at each one of a set of predetermined delimiters to produce respective test and reference sets of sequentially ordered string chunks;
iteratively comparing string chunks of the same order to determine if matching therebetween, wherein the comparison of same-order string chunks continues until a non-matching same-order string chunk pair is encountered; and
determining that a specified quality relationship exists between the reference and test version strings if the matching comparisons satisfy a set of predetermined matching/non-matching conditions, wherein the specified quality relationship determines the presence of a vulnerability in the computing environment due to the test version of the computer code.

62. The method as in claim 61,
wherein the reference version string is selected from a known list of versions of the computer code having vulnerabilities, and the specified quality relationship to be determined is version equivalence.
